(19) United States
(12) Patent Application Publication
(10) Pub. No.: US 2010/0217730 A1
(43) Pub. Date: Aug. 26, 2010

(54) TEMPORALLY-CONTROLLED ITEM RECOMMENDATION METHOD AND SYSTEM BASED ON RATING PREDICTION

(75) Inventors: Min Zhao, Beijing (CN); Toshikazu Fukushima, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) Co., Ltd., Beijing (CN)

(21) Appl. No.: 12/645,078

(22) Filed: Dec. 22, 2009

(30) Foreign Application Priority Data
Feb. 24, 2009 (CN) 200910005395.3

(51) Int. Cl. G06N 5/02; G06F 15/18

(52) U.S. Cl. 706/12; 706/58

(57) ABSTRACT

The present invention proposes a temporally-controlled item recommendation method and system based on rating prediction. According to this invention, the item recommendation method comprises inputting an item to be recommended; determining a temporal rating model related to the item, the temporal rating model being used to predict variation of the rating of the item with time; applying one or more recommendation strategies to the determined temporal rating model to determine optimal recommendation times of the item; and recommending the item to a user at the determined optimal recommendation times. In different embodiments, the temporal rating model of the item can be selected from a set of pre-stored temporal rating models or automatically generated according to history data in the system. In addition, the selected temporal rating model can be adjusted in accordance with user preference information or user feedback information. The item recommendation system of this invention is able to consider the change of a user's interest in a given item with time so as to increase the effectiveness of recommendations and improve user experience.

### FIELD OF THE INVENTION

The present invention generally relates to information filtering, and more particularly, to an item recommendation method and system, which can implement temporally-controlled item recommendations based on rating prediction.

### BACKGROUND

Recommender systems have been deployed in commercial applications for more than ten years. For a given user, a recommender system collects and records information on user's profile, and predicts items the user may be interested in. The profile could be personal information such as age, education and hobbies, or answers to some given questions, or votes (ratings) on certain items, or web browsing history, or online purchasing record, and so on. The predictions may be based on some predefined rule set, statistical models, or machine learning algorithms.

Recently, with the popularization of online behaviors such as online shopping, social network, and personalized subscription, recommender systems are applied more and more widely to web and mobile applications. Internet and mobile users utilize recommender systems to get suggestions on daily life such as which restaurant to eat, what kind of book to read, which movie to watch and where to travel.

Conventional recommender systems do not consider the variations of user's interest to given recommendations, and always recommend items with high confidence level. However, an item with high confidence level may not keep its value to a user. For example, if a film with high confidence level is first released as a cult movie and later become a blockbuster, then it is less value to recommend the film when it being a blockbuster than as a cult movie, since a blockbuster film is well-known and not need to be recommended. In addition, user's interest to a fixed item may change with time. A recommended film may be much more attracting at weekend night than business hour, and a user may be more likely to accept a recommendation on restaurant before dinner time rather than after that. However, conventional recommender systems do not consider the change of user's interest in different time for a given item.

U.S. Pat. No. 6,334,127 presents a new type of recommender system different from conventional technology, which is used to generate serendipity-controlled recommendations. FIG. 1A shows a general block diagram of a recommender system 100 based on item serendipity, and FIG. 1B shows the operation flows of the system 100. As shown in FIG. 1A, the system 100 includes a recommended item storage 101, an item inputting means 102, a serendipity model storage 103, a serendipity integration means 104 and a serendipity-weighted item storage 105. Referring to FIG. 1B, at step 101a, the item inputting means 102 can input an item to be recommended from the recommended item storage 101. Please note that the recommended item storage 101 stores items without regard to serendipity. Such items to be recommended could be generated by many existing methods, such as user item preference, community item popularity, and etc. At step 102a, the serendipity integration means 104, from the serendipity-weighted item storage 105, selects a suitable serendipity model for each input item and computes a serendipity-weighted value of each item according to the selected model. Then the serendipity-weighted items can be stored in the serendipity-weighted item storage 105.

As stated above, the serendipity-controlled recommender system provides serendipity-weighted recommendations to avoid recommending low-value item with high confidence level to users. However, it cannot reflect the change of user's interest in a given item with time. That is, it cannot decide when is the best time that an item should be recommended to a user.

### SUMMARY OF THE INVENTION

The present invention for providing a temporally-controlled item recommendation method and system based on rating prediction is developed in view of the abovementioned problem. The main idea of this invention lies in incorporating temporal factors into the computation of item ratings and recommending items to users based on the computed optimal recommendation times.

According to the first aspect of this invention, a temporally-controlled item recommendation method based on rating prediction is provided. This method comprises inputting an item to be recommended; determining a temporal rating model related to the item, the temporal rating model being used to predict variation of the rating of the item with time; applying one or more recommendation strategies to the determined temporal rating model to determine optimal recommendation times of the item; and recommending the item to a user at the determined optimal recommendation times.

According to the second aspect of this invention, a temporally-controlled item recommendation system based on rating prediction is provided. This system comprises an item inputting means for inputting an item to be recommended; a temporal rating model determination means for determining a temporal rating model related to the item, the temporal rating model being used to predict variation of the rating of the item with time; a recommendation strategy application means for applying one or more recommendation strategies to the determined temporal rating model to determine optimal recommendation times of the item; and an item recommendation means for recommending the item to a user at the determined optimal recommendation times.

In different embodiments, the present invention proposes multiple methods for determining a temporal rating model related to the item. For example, in one embodiment, the category that the item to be recommended belongs to can be first determined. Here, different categories can be related to different temporal characteristics, i.e. correspond to different temporal rating models. Then a temporal rating model suitable for the item is selected from a set of pre-stored temporal rating models according to the category of the item. And then one or more recommendation strategies can be applied to the selected temporal rating model to determine optimal recommendation times of the item. The recommendation strategies here can be related to points of time, number of times and periods for recommending the item.

In another embodiment, preference information of users for recommendation of the item can be used to adjust the selected temporal rating model to obtain personalized temporal rating models of the item for different users.

In another embodiment, feedback information of a particular user about recommendation of the item can be collected as the user's implicit preferences and be used to adjust the selected temporal rating model to thereby obtain a personalized temporal rating model for the user.

In another embodiment, history data on item recommendations in a recommender system can be recorded and stored to train and generate, for any individual item, the temporal rating model related to the item.

The recommender system of the present invention can also be combined with any existing recommender system (e.g. the serendipity-controlled recommender system), take the items generated according to conventional technology as candidate items of the invention to input and thereby introduce temporal factors into conventional existing recommender systems.

The main positive effect of the invention is to recommend an item to a user in optimal recommendation times so that the variations of the item recommendation with time can be taken into consideration, so as to increase the effectiveness of recommendations and to improve user experience.

Furthermore, in extended embodiments, the system and method of this invention can adapt the optimal recommendation times of items to requirements of different users, that is, the optimal recommendation times for an item can be adjusted according to preferences or feedback information of different users instead of remaining same to all users. In addition, according to a different embodiment, the temporal rating model of an item can be learned in accordance with history data in the system and a set of pre-stored temporal rating models is not needed.

Other features and advantages of the present invention will be apparent from the following detailed description in conjunction with the accompanying drawings. Please note that this invention is not limited to the examples shown in the drawings or any specific embodiments.

### BRIEF DESCRIPTIONS OF THE DRAWINGS

The present invention will be better understood from the following detailed description of the embodiments of the invention in conjunction with the accompanying drawings, in which like reference numerals refer to similar parts and in which:

FIG. 1A is a block diagram of a serendipity-controlled recommender system 100 according to existing technology;

FIG. 1B is a flowchart that illustrates an operation process of the system 100 shown in FIG. 1A;

FIG. 2A is a block diagram that illustrates the general structure of a temporally-controlled item recommendation system 200 based on rating prediction according to the present invention;

FIG. 2B is a flowchart that illustrates an operation process of the system 200 shown in FIG. 2A;

FIG. 3 is a block diagram that illustrates the internal structure of an item recommendation system 300 according to the first embodiment of the present invention;

FIG. 4A is a schematic diagram for explaining the structure of a temporal rating model set;

FIG. 4B is a schematic diagram for explaining recommendation strategy selection;

FIG. 5 is a flowchart that illustrates an operation process of the system 300 shown in FIG. 3;

FIG. 6 is a block diagram that illustrates the internal structure of an item recommendation system 600 according to the second embodiment of the present invention;

FIG. 7A is a schematic diagram for explaining the process of adjusting a temporal rating model according to user preference information;

FIG. 7B is a flowchart that illustrates an operation process of the system 600 shown in FIG. 6;

FIG. 8A is a block diagram that illustrates the internal structure of an item recommendation system 800 according to the third embodiment of the present invention;

FIG. 8B is a flowchart that illustrates an operation process of the system 800 shown in FIG. 8A;

FIG. 9A is a block diagram that illustrates the internal structure of an item recommendation system 900 according to the fourth embodiment of the present invention;

FIG. 9B is a flowchart that illustrates an operation process of the system 900 shown in FIG. 9A;

FIG. 10A is a block diagram for illustrating a complete system 1000 reached by combining the item recommendation system of the invention, i.e. one of the systems 300, 600, 800 and 900, with a conventional recommender system; and

FIG. 10B is a flowchart that illustrates an operation process of the system 1000 shown in FIG. 10A.

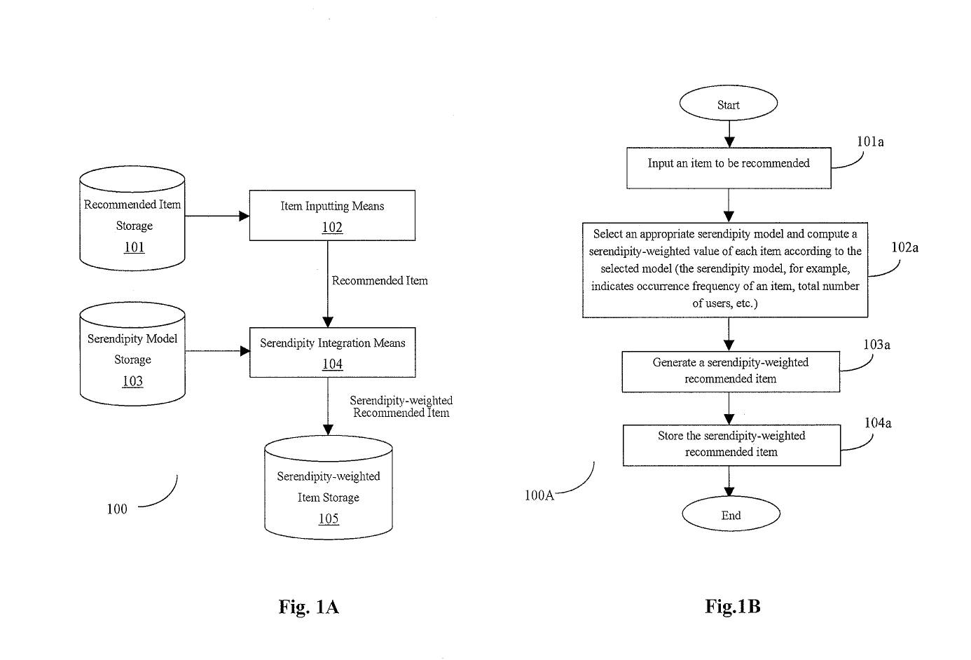

### DETAILED DESCRIPTION OF THE PREFERRED EMBODIMENTS

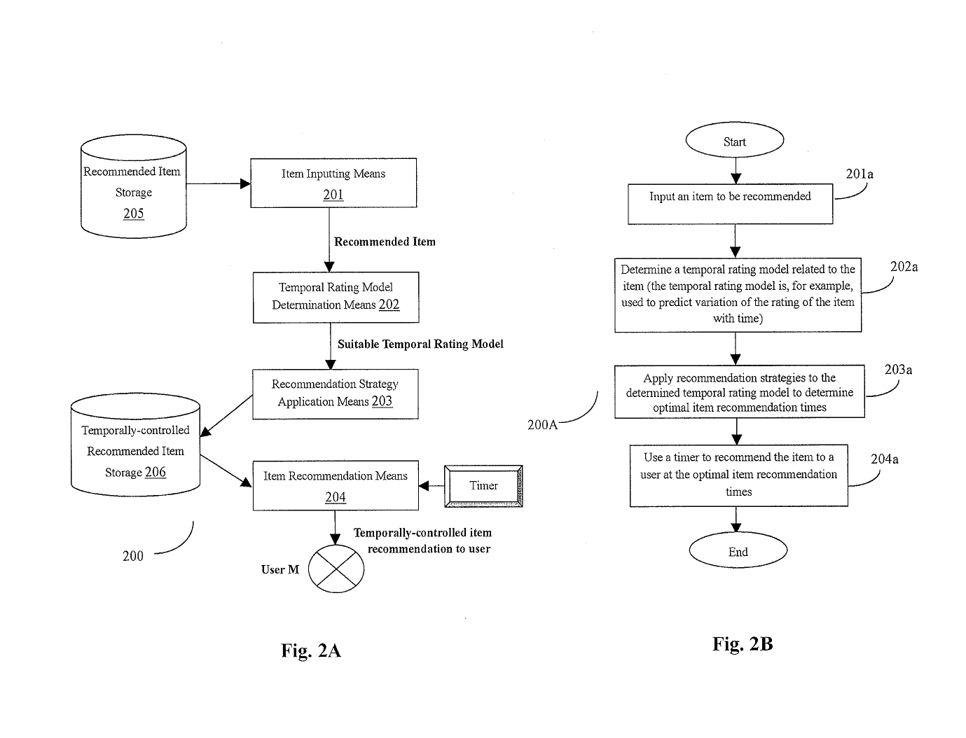

FIG. 2A is a block diagram that illustrates the general structure of a temporally-controlled item recommendation system 200 based on rating prediction according to the present invention. As shown in FIG. 2A, the item recommendation system 200 comprises an item inputting means 201, a temporal rating model determination means 202, a recommendation strategy application means 203, an item recommendation means 204, a recommended item storage 205 and a temporally-controlled recommended item storage 206.

FIG. 2B is a flowchart that illustrates an operation process of the system 200 shown in FIG. 2A. In FIG. 2B, a process 200A starts from step 201a, at which the item inputting means 201 inputs an item A to be recommended from the recommended item storage 205. The items stored in the recommended item storage 205 can be given in advance or generated automatically by employing existing recommendation technology, as will be described later. What should be noted is that the recommended item storage 205 stores items without regard to temporal factors. Next, at step 202a, the temporal rating model determination means 202 determines a temporal rating model Rᵢ(t) related to the input item A, which can, for example, be used to predict variation of the rating of the item with time. The obtaining of the temporal rating model will be described in detail later with reference to embodiments. Then, at step 203a, the recommendation strategy application means 203 applies one or more recommendation strategies to the determined temporal rating model to determine optimal recommendation times for recommending the item A to a user. The “recommendation strategies” described here can be related to factors such as points of time, number of times and periods for recommending the item. Later, a temporally-controlled recommended item that takes recommendation times into consideration can be stored in the temporally-controlled recommended item storage 206 to wait for being recommended to the user. At step 204a, the item recommendation means 204 can utilize a timer so as to recommend the item to the user at the optimal recommendation times determined by the recommendation strategy application means 203. Then the process 200A comes to an end.

In the present invention, the temporal rating model related to the item can be generated by many ways according to different embodiments. For example, the temporal rating model can be selected from a set of pre-stored temporal rating models according to the category of the item or generated automatically according to history data in the recommendation system. Detailed explanations will be given below in conjunction with different embodiments.

### First Embodiment

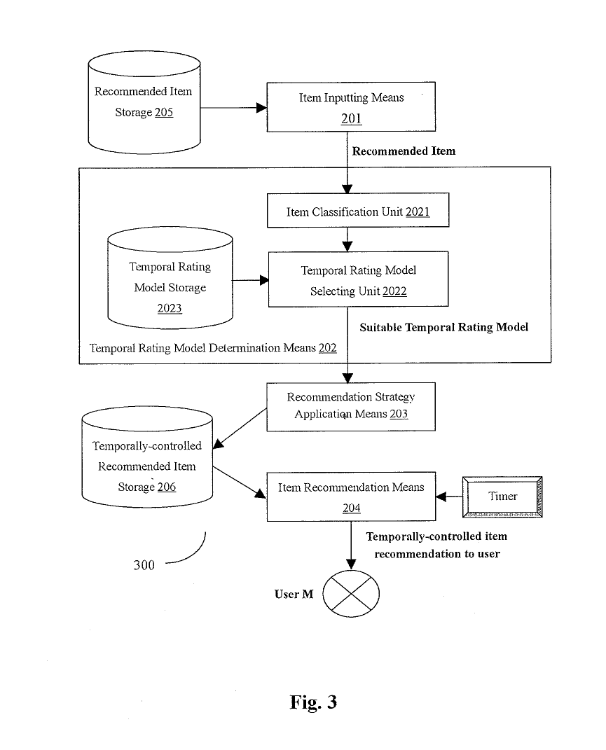

FIG. 3 is a block diagram that illustrates the internal structure of an item recommendation system 300 according to the first embodiment of the present invention. As shown in FIG. 3, the general structure of the system 300 is similar to that of the system 200 shown in FIG. 2A, but FIG. 3 differs from FIG. 2A in that it further illustrates the internal structure of the temporal rating model determination means 202 in detail. In FIG. 3, the temporal rating model determination means 202 includes an item classification unit 2021, a temporal rating model selecting unit 2022 and a temporal rating model storage 2023.

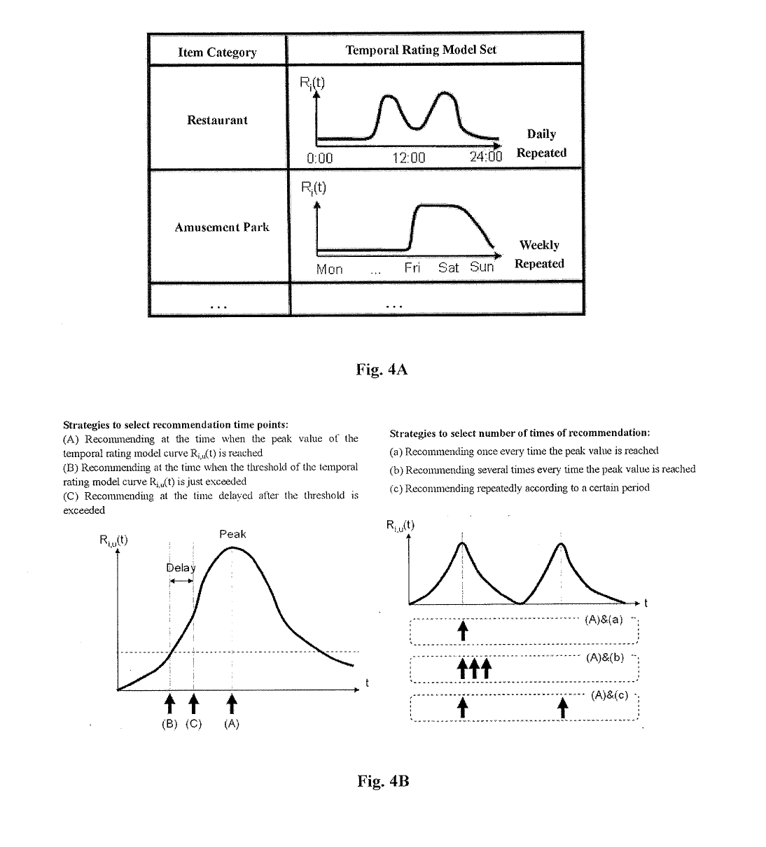

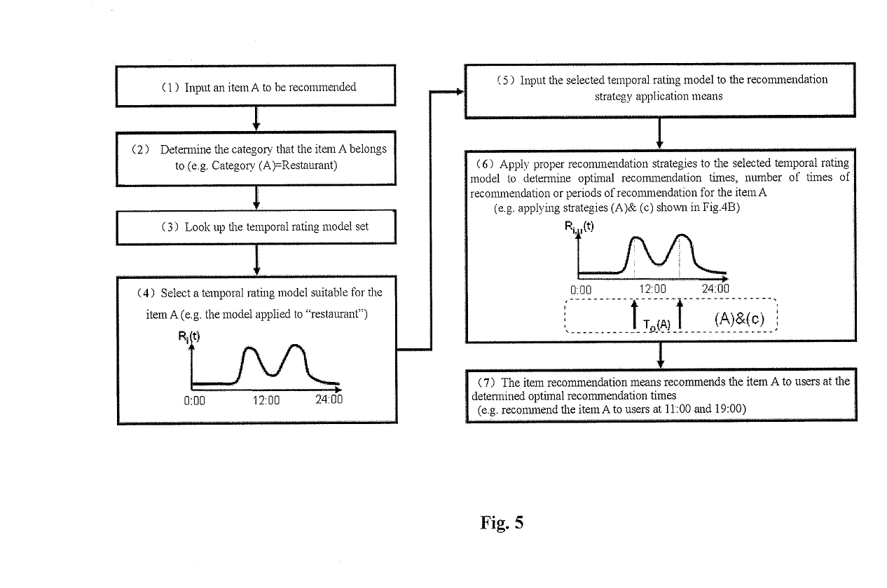

FIG. 5 is a flowchart that illustrates an operation process of the system 300 shown in FIG. 3. For the convenience of explanation, the description further gives FIG. 4A which is a schematic diagram for explaining the structure of a temporal rating model set and FIG. 4B which is a schematic diagram for explaining recommendation strategy selection.

Referring to FIG. 5, first, the item inputting means 201 inputs an item A to he recommended. Then, the item classification unit 2021 in the temporal rating model determination means 202 can be used to determine the category that the item A belongs to. Next, the temporal rating model selecting unit 2022 can make a search in the temporal rating model storage 2023 to select a temporal rating model Rᵢ(t) suitable for the item A. FIG. 4A shows the structure of a temporal rating model set stored in the temporal rating model storage 2023. Although FIG. 4A merely shows two categories of temporal rating models, i.e. “restaurant” and “amusement park”, obviously, temporal rating models that can be used for the present invention are not limited to the two categories mentioned above. Furthermore, in FIG. 4A, the temporal rating model is, for example, shown in the form of a time curve, in which the horizontal coordinate denotes time and the vertical coordinate denotes variation of the rating of the item with time. However, temporal rating models that can be used for the present invention are not limited to the form mentioned above, and other models that can be used to show variation of the rating of the item with time may also be similarly applied to the invention. It can be seen from FIG. 4A that the two temporal rating models of “restaurant” category and “amusement park” category have different temporal characteristics: the model of “restaurant” category has two peaks and repeats everyday, while the model of “amusement park” category has one peak but lasts longer and repeats every week. By looking up this table, the temporal rating model Rᵢ(t) suitable for the item A can be readily obtained.

Referring to FIG. 5 continuously, for example, the temporal rating model of “restaurant” category is selected for the item A (see step (4) in FIG. 5). Then the selected temporal rating model is provided to the recommendation strategy application means 203. The recommendation strategy application means 203 applies one or more appropriate recommendation strategies to the selected temporal rating model to determine optimal recommendation time points, number of times of recommendation or periods of recommendation for the item A.

FIG. 4B shows several possible recommendation strategies as an example. Strategies to select the recommendation time points are shown in the left-hand part of FIG. 4B. Particularly, strategies such as the following three different ones can be included: (A) Recommending at the time when the peak value of the temporal rating model curve R_{i,u}(t) is reached; (B) Recommending at the time when the threshold of the temporal rating model curve R_{i,u}(t) is just exceeded; and (C) Recommending at the time delayed after the threshold is exceeded. The right-hand part of FIG. 4B shows strategies to select number of times of recommendation, which, for example, can include three different strategies: (a) Recommending once every time the peak value is reached; (b) Recommending several times every time the peak value is reached; and (c) Recommending repeatedly according to a certain period. By combining different recommendation strategies, the recommendation strategy application means 203 can select optimal item recommendation times according to a temporal rating model.

Referring to FIG. 5 continuously, at step (6), the application of recommendation strategies is shown by taking the combination of recommendation strategies (A) and (c) shown in FIG. 4B as an example. By applying the recommendation strategies, it can he determined that the optimal recommendation time points for the item A are 11:00 and 19:00 every day. Then the item marked with the optimal recommendation time points can be stored in the temporally-controlled recommended item storage 206 to be recommended to users. The item recommendation means 204 can use a timer to recommend the item A of “restaurant” category to users at 11:00 and 19:00 every day.

### Second Embodiment

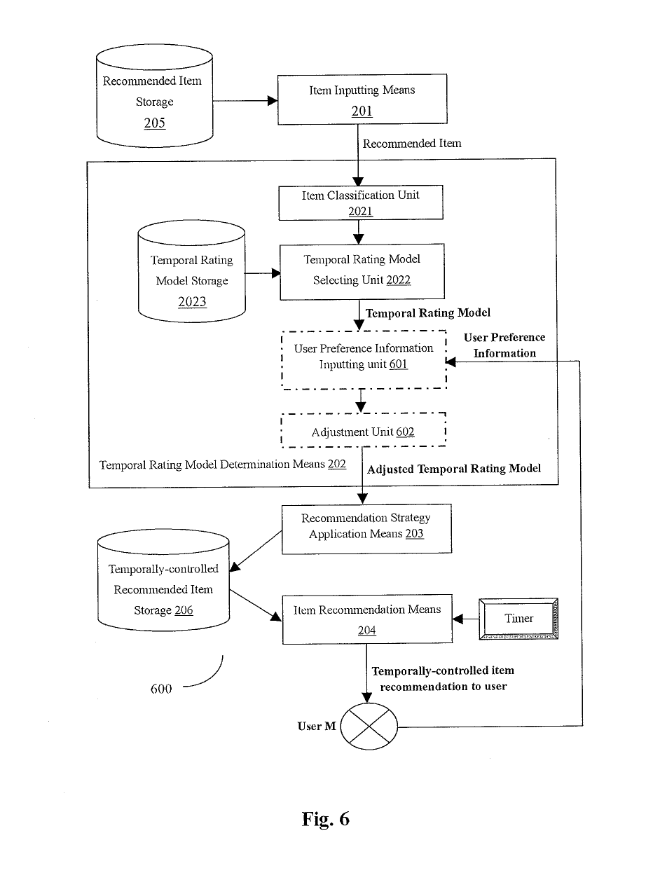

FIG. 6 is a block diagram that illustrates the internal structure of an item recommendation system 600 according to the second embodiment of the present invention. The system 600, similar to the system 300 shown in FIG. 3, has a difference only in that the temporal rating model determination means 202 in the system 600 further comprises a user preference information inputting unit 601 and an adjustment unit 602 in addition to the components shown in FIG. 3, which are used to adjust the selected temporal rating model according to preference information of different users so that optimal recommendation times of an item finally determined can be adapted to requirements of different users. The “user preference information” here can be easily acquired from a user's schedule, behavior tracking record, or other resources.

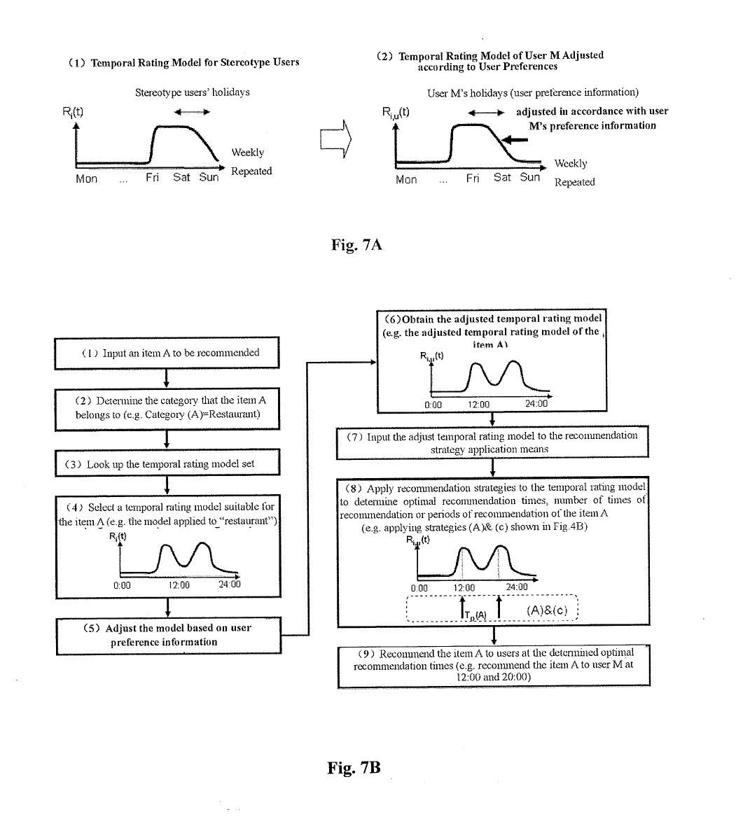

FIG. 7A is a schematic diagram for explaining the process of adjusting a temporal rating model according to user preference information. In this example, the peak value of a temporal rating curve for stereotype users' holidays is from Friday to Sunday and decreases on Sunday, and then the peak value is shifted to Friday and decreases on Saturday after the temporal rating model is adjusted according to the preference information of user M.

FIG. 7B is a flowchart that illustrates an operation process of the system 600 shown in FIG. 6. The operation process, similar to that of the system 300 shown in FIG. 5, has a difference merely in adding steps (5) and (6) (shown in bold) to implement adjustment of a temporal rating model according to user preference information. After adjustment, the optimal recommendation times determined by the recommendation strategy application means 203 may be different from the first embodiment, for example, the optimal recommendation times are determined as 12:00 and 20:00 every day.

In the second embodiment, the optimal recommendation times for an item A may vary with different users instead of remaining same to all users. In this way, it can be achieved that item recommendations are adapted to requirements of different users.

### Third Embodiment

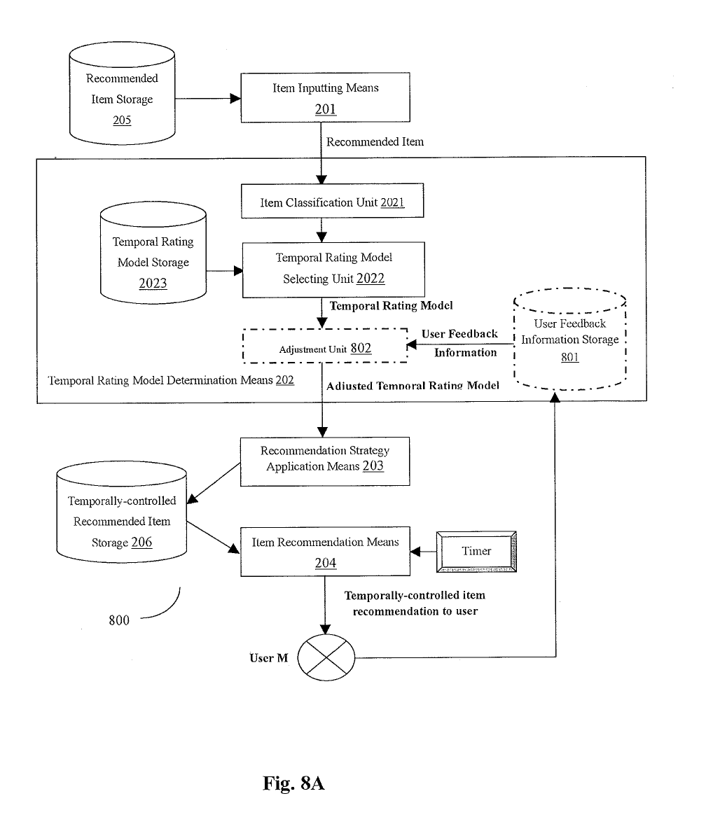

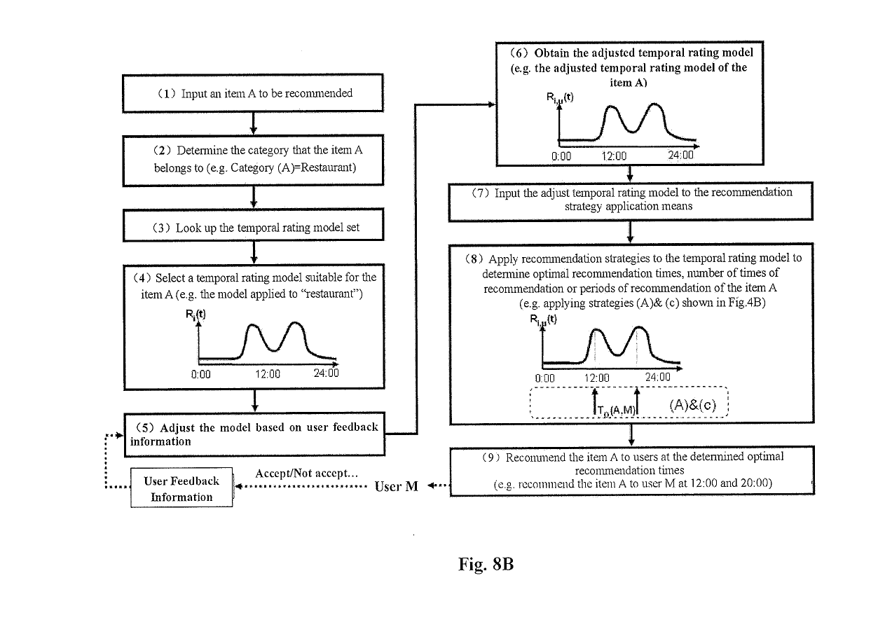

FIG. 8A is a block diagram that illustrates the internal structure of an item recommendation system 800 according to the third embodiment of the present invention, and FIG. 8B is a flowchart that illustrates an operation process of the system 800 shown in FIG. 8A.

The system 800 in the third embodiment, similar to the system 600 described in the second embodiment, has a difference in acquiring a user's personalized requirements on item recommendations by collecting feedback information of a user about received items instead of inputting user preference information.

As shown in FIG. 8A, the temporal rating model determination means 202 in the system 800 further comprises a user feedback information storage 801 for storing feedback information of a user about received item recommendations and an adjustment unit 802 for adjusting the selected temporal rating model according to the user feedback information, i.e. adjusting the temporal rating model Rᵢ(t) to R_{i,u}(t), in addition to the components shown in the first and second embodiments.

In the third embodiment, the system adopts a feedback mechanism to collect a user's implicit preferences for item recommendations so as to adjust the temporal rating model according to the user's requirements. By this way the burden can be avoided to collect a user's preferences as needed in the second embodiment. Such mechanism is beneficial when it is hard to obtain user preference information before making recommendations.

### Fourth Embodiment

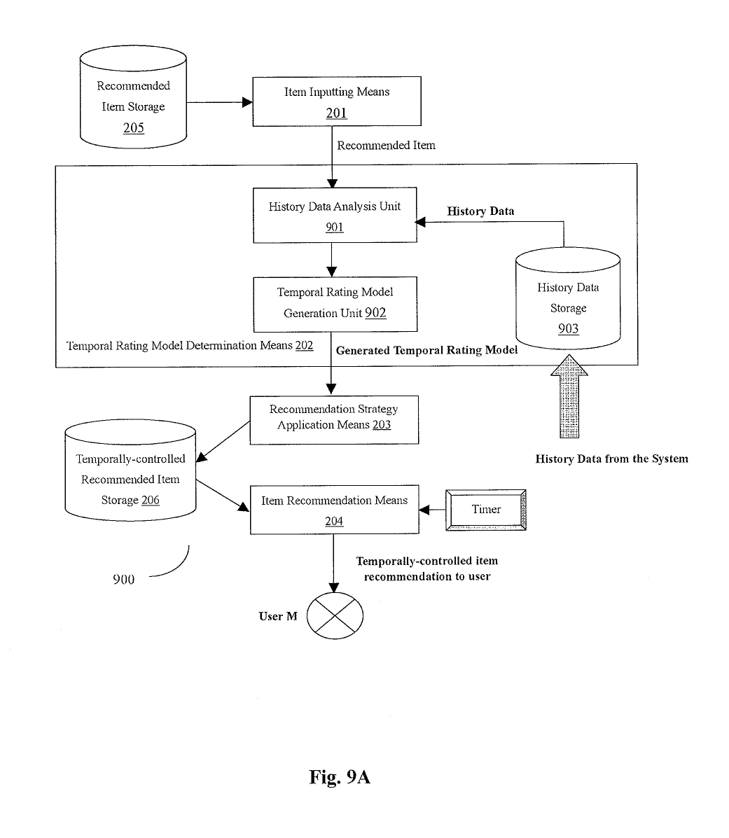

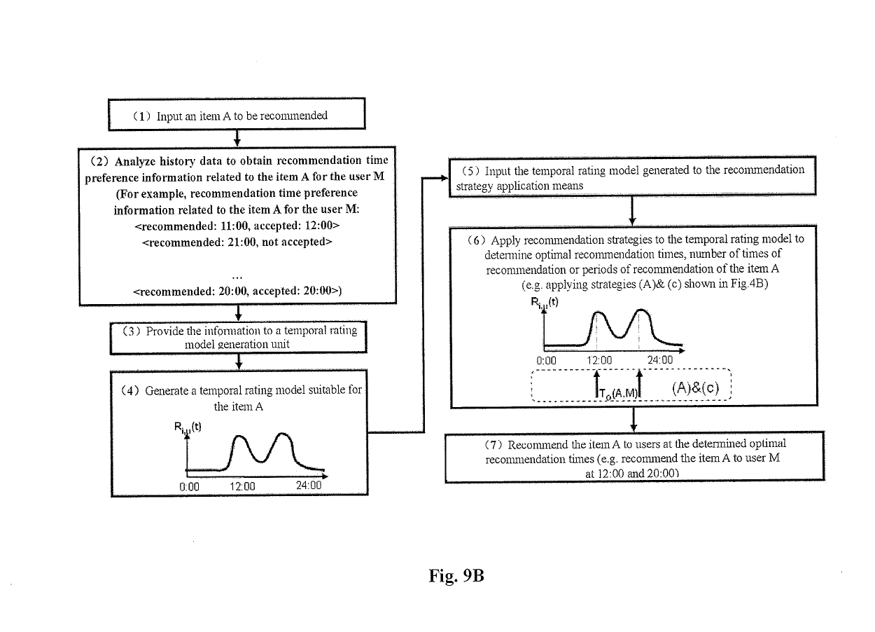

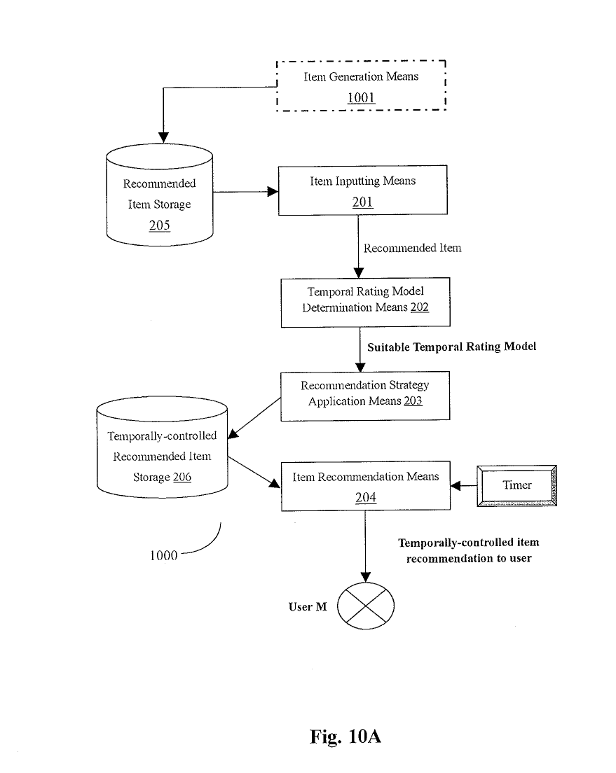

In the first, second and third embodiments as described in the preceding text, the recommender system selects a temporal rating model suitable for a particular item from a set of pre-stored temporal rating models, which is suitable for well-understood categories. However, for some special categories, the user may not obtain temporal rating models related thereto in advance. In this case, other methods need to be used to determine a temporal rating model related to the item. The fourth embodiment shown in FIGS. 9A and 9B can be used to solve this problem.

FIG. 9A is a block diagram that illustrates the internal structure of an item recommendation system 900 according to the fourth embodiment of the present invention, and FIG. 9B is a flowchart that illustrates an operation process of the system 900 shown in FIG. 9A.

The system 900 shown in FIG. 9A differs from the first, second and third embodiments in the structure of the temporal rating model determination means 202. And other components in theses system are substantially the same. As shown in FIG. 9A, the temporal rating model determination means 202 in the system 900 comprises a history data analysis unit 901, a temporal rating model generation unit 902 and a history data storage 903, which is capable of recording recommendation history in the recommender system, such as which items are recommended to users, recommendation times of the items, if the items are accepted by the user, and so on.

Referring to FIG. 9B, similarly to the embodiments mentioned above, the item inputting means 201 inputs an item A to be recommended first. Then the history data analysis unit 901 analyzes history data stored in the history data storage 903 to generate recommendation time preference information of a user (e.g. user M) for the item A. For example, the recommendation time preference information can be presented as <recommended: 11:00, accepted: 12:00>, <recommended: 21:00, not accepted>, . . . <recommended: 20:00, accepted: 20:00>. Of course, the presentation method of recommendation time preference information is not limited thereto and can be designed according to requirements of users. Then, the recommendation time preference information generated can be provided to the temporal rating model generation unit 902. The temporal rating model generation unit 902 can generate the temporal rating model related to the item A for the user M by learning according to the received user M′s recommendation time preference information. With respect to the learning method for generating a temporal rating model, any method well known in the art can be used, such as simple statistics, decision tree, k-order Markov model, regression etc.

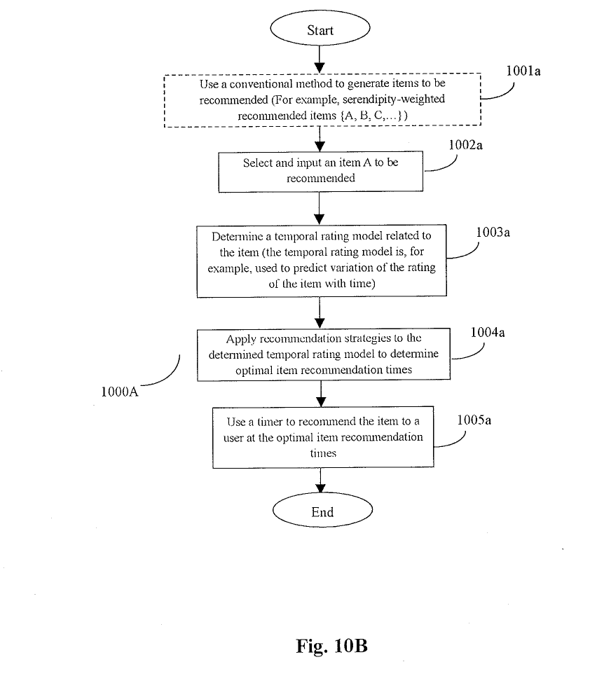

As mentioned above, the temporally-controlled item recommendation strategies proposed by this invention can be combined with any existing item recommendation method (e.g. the serendipity-controlled item recommendation method). FIG. 10A is a block diagram for illustrating a complete system 1000 reached by combining the item recommendation system of the invention, i.e. one of the systems 300, 600, 800 and 900, with a conventional recommender system. FIG. 10B is a flowchart that illustrates an operation process of the system 1000 shown in FIG. 10A.

In the system 1000, an item generation means 1001 can adopt any existing item recommendation method to generate candidate items to be recommended (see step 1001a in FIG. 10B). The existing item recommendation method is, for example, collaborative filtering, content-based filtering, rule-based filtering, and hybrid filtering. The structures and functions of other components in the system 1000 shown in FIG. 10A are the same as those in the system 200 shown in FIG. 2A, that is, any of the structures in the first, second, third and fourth embodiments can be used.

The controlled item recommendation system and method based on rating prediction according to the present invention has been described above. It can be seen from the abovementioned description that this invention has the following positive effects:

The main positive effect of the invention is to recommend an item to a user in optimal recommendation times so that variations of the item recommendation with time can be taken into consideration, so as to increase the effectiveness of recommendations and to improve user experience.

Furthermore, the system and method of this invention can adapt the optimal recommendation times of items to requirements of different users, that is, the optimal recommendation times for an item can be adjusted according to preferences or feedback information of different users instead of remaining same to all users. In addition, according to a different embodiment, the temporal rating model of an item can be learned in accordance with history data in the system and a set of pre-stored temporal rating models is not needed.

The specific embodiments according to the present invention have been described above with reference to the accompanying drawings. However, the invention is not limited to the particular configurations and processes shown in the drawings. And for the sake of conciseness, the detailed description of known methods and technologies has been omitted. In the abovementioned embodiments, several specific steps have been described and shown as examples. But the methods and processes of the invention are not limited to the specific steps described and shown, and those skilled in the art could, after understanding the spirit of the invention, make various variations, modifications and additions or change the sequence between the steps.

The elements of the invention can be implemented as hardware, software, firmware or their combinations and can be used in their systems, subsystems, components or subcomponents. When implemented in the way of software, the elements of the invention are programs or code sections for performing required tasks. The programs or code sections can be stored in a machine-readable medium or transferred over a transmission medium or a communication link through data signals carried in carrier waves. The “machine-readable medium” can include any medium capable of storing or transmitting information. The examples of “machine-readable medium” include electronic circuit, semiconductor memory device, ROM, flash memory, EROM, floppy disk, CD-ROM, optical disk, hard disk, fiber medium, RF link, etc. Code sections can be downloaded via a computer network such as Internet or Intranet.

This invention can be implemented in other specific forms without departing from its spirit and essential characteristics. For instance, the algorithms described in the particular embodiments can be modified but the system architecture does not depart from the basic spirit of the invention. Therefore, the current embodiments are regarded in an illustrative rather than a restrictive sense in all aspects. The scope of the invention is defined by the appended claims rather than the abovementioned description, thus all the variations that fall within the scope of the claims or the equivalents thereof will be included in the scope of the invention.

What is claimed is:

1. A temporally-controlled item recommendation method based on rating prediction, comprising:
inputting an item to be recommended;
determining a temporal rating model related to the item, the temporal rating model being used to predict variation of the rating of the item with time;
applying one or more recommendation strategies to the determined temporal rating model to determine optimal recommendation times of the item; and
recommending the item to a user at the determined optimal recommendation times.

2. The method according to claim 1, wherein the step of determining the temporal rating model comprises:
determining the category that the item belongs to; and
selecting, from a set of pre-stored temporal rating models, a suitable temporal rating model for the item according to the determined category of the item.

3. The method according to claim 2, wherein the step of determining the temporal rating model further comprises:
inputting user preference information of the user for recommendation time of the item; and
adjusting the selected temporal rating model according to the user preference information.

4. The method according to claim 2, wherein the step of determining the temporal rating model further comprises:
recording user feedback information, which is about recommendation time of the items that have been received by the user; and
adjusting the selected temporal rating model according to the user feedback information.

5. The method according to claim 1, wherein the step of determining the temporal rating model comprises:
collecting history data on item recommendation history in a recommender system;
analyzing the history data to obtain recommendation time preference information of the user for the item; and
generating the temporal rating model related to the item based on the obtained recommendation time preference information.

6. The method according to claim 1, further comprising:
using a traditional recommendation method to generate the item to be recommended.

7. The method according to claim 6, wherein the traditional recommendation method is at least one selected from the group of
collaborative filtering;
content-based filtering;
rule-based filtering; and
hybrid filtering.

8. The method according to claim 1, wherein the recommendation strategies are used to indicate points of time, periods and number of times for recommending the item.

9. A temporally-controlled item recommendation system based on rating prediction, comprising:
an item inputting means for inputting an item to be recommended;
a temporal rating model determination means for determining a temporal rating model related to the item, the temporal rating model being used to predict variation of the rating of the item with time;
a recommendation strategy application means for applying one or more recommendation strategies to the determined temporal rating model to determine optimal recommendation times of the item; and
an item recommendation means for recommending the item to a user at the determined optimal recommendation times.

10. The system according to claim 9, wherein the temporal rating model determination means comprises:
a temporal rating model storage for storing a set of temporal rating models relative to categories of items
an item classification unit for determining the category that the item belongs to; and
a temporal rating model selecting unit for selecting, from the set of temporal rating models stored in the temporal rating model storage, a suitable temporal rating model for the item according to the determined category of the item.

11. The system according to claim 10, wherein the temporal rating model determination means further comprises:
a user preference information inputting unit for inputting user preference information of the user for recommendation time of the item; and
an adjustment unit for adjusting the selected temporal rating model according to the user preference information.

12. The system according to claim 10, wherein the temporal rating model determination means further comprises:
a user feedback information storage for recording user feedback information, which is about recommendation time of the items that have been received by the user; and
an adjustment unit for adjusting the selected temporal rating model according to the user feedback information.

13. The system according to claim 9, wherein the temporal rating model determination means comprises:
a history data storage for recording history data on item recommendation history in the system;
a history data analysis unit for analyzing the history data to obtain recommendation time preference information of the user for the item; and
a temporal rating model generation unit for generating the temporal rating model related to the item based on the obtained recommendation time preference information.

14. The system according to claim 9, further comprising:
an item generation means for using a traditional recommendation method to generate the item to be recommended.

15. The system according to claim 9, further comprising a timer, and wherein the item recommendation means recommends the item to the user at the determined optimal recommendation times with the timer.
